(19) United States
(12) Patent Application Publication
(10) Pub. No.: US 2018/0035280 A1
(43) Pub. Date: Feb. 1, 2018

(54) FREQUENT CHANGE OF SSID MESSAGE FOR AD-HOC DATA DELIVERY

(71) Applicant: WEFIND-TECH LTD, TEL AVIV (IL)

(72) Inventors: Ofer KLEIN, TEL-AVIV (IL); Joshua BARBASH, TEL AVIV (IL)

(73) Assignee: WEFIND-TECH LTD, TEL AVIV (IL)

(21) Appl. No.: 15/127,098

(22) PCT Filed: Mar. 18, 2015
(86) PCT No.: PCT/IL15/50286

§ 371 Date: Sep. 19, 2016

Related U.S. Application Data
(60) Provisional application No. 61/955,835, filed on Mar. 20, 2014.

(51) Int. Cl. H04W 8/18

(52) U.S. Cl. CPC H04W 8/183; H04W 84/18

(57) ABSTRACT

A wireless communication system for delivering ad-hoc data from a plurality of at least device, D_{i (i=1 . . . N)}, with each device comprising a communication-module configured for wireless communication with a predetermined environment, and a non-transitory computer readable medium (CRM) configured to control the communication-module [130]; wherein the CRM [110] further comprises a coding-module configured to periodically assign an updated SSID string to be broadcasted by the communication-module; further wherein the SSID is associated with the data such that the wireless communication is implemented by utilizing the SSID string. BACKGROUND OF THE INVENTION An SSID is a unique ID that consists of up to 32 characters and is used for naming wireless networks. When multiple wireless networks overlap in a certain location, SSIDs make sure that data gets sent to the correct destination. Each packet sent over a wireless network includes the SSID, which ensures that the data being sent over the air arrives at the correct location. Without service set identifiers, sending and receiving data in a location with multiple wireless networks would be chaotic and unpredictable to say the least. There is an unmet need for a system or method that frequently changes the SSID of a communicating device to a message for delivering ad-hoc data or information for applications like Many-To-Many devices communication.

### SUMMARY OF THE INVENTION

It is thus one object of the present invention to disclose a wireless communication system [100] for delivering ad-hoc data from at least one device D_{i (i=1 . . . N)} [120], with each said device Dᵢ [120] comprising a communication-module [130] configured for the wireless communication with a predetermined environment [140], and a non-transitory computer readable medium (CRM) [110] configured to control the communication-module [130];

wherein the CRM [110] further comprises a coding-module [150] configured to periodically assign an updated SSID [135] to be broadcasted by the communication-module [130]; wherein the SSID [135] is associated with the data; such that the wireless communication is implemented by utilizing the SSID [135].

It is another object of the present invention to disclose the system mentioned above, wherein the environment [140] comprises a decoding-module [155], configured for decoding the SSID [135] back to the data.

It is another object of the present invention to disclose the system mentioned above, wherein the SSID [135] is coded and/or decoded according to a predetermined coding-algorithm.

It is another object of the present invention to disclose the system mentioned above, wherein the SSID [135] is coded and/or decoded according to a predetermined a coding-database [160], stored in the CRM [120] and/or the environment [140].

It is another object of the present invention to disclose the system mentioned above, wherein the communication-module [130] does not require a password for wireless communication.

It is another object of the present invention to disclose the system mentioned above, wherein a password for the communication-module [130] is retrieved from the database [160].

It is another object of the present invention to disclose the system mentioned above, wherein the communication module [130], of at least one device Dᵢ [120], is configured as a relay or an access-point facilitating wireless communication from at least one other device D_{j≠i} [120] to the environment [140].

It is another object of the present invention to disclose the system mentioned above, wherein the environment [140] is selected from a group comprised of: wireless router, access point, mobile-phone, at least one other device D_{j≠i}, and any combination thereof.

It is another object of the present invention to disclose the system mentioned above, wherein the data of the device [120] is continuously and periodically updated and accordingly the SSID [135] is broadcasted in a time period selected from a group comprised of: milliseconds, seconds, minutes, hours, days, and any combination thereof.

It is another object of the present invention to disclose the system mentioned above, wherein the SSID [135] of at least one device Dᵢ [120] is configured to reflect the data of at least one other device D_{j≠i} [120].

It is another object of the present invention to disclose the system mentioned above, wherein the at least one device Dᵢ [120] is physically attachable to an object and/or mammalian subject.

It is another object of the present invention to disclose the system mentioned above, wherein at least one device Dᵢ [120] further comprises at least one sensor [200], in communication with the CRM [110], selected from a group comprised of: accelerometer [201], GPS [202], gyro [203], magnetometer [204], sound detector [205], light detector [206], motion detector [207], thermometer [208], blood pressure monitoring device [209], blood glucose monitoring device [210], heart rate monitoring device [211], location-detector [212], proximity-detector [213] and any combination thereof.

It is another object of the present invention to disclose the system mentioned above, wherein the data is selected from a group comprised of: reception quality, the network status, the network performance, battery status, connectivity level, accuracy, the sensor's [200] availability, the sensor's [200] readings, the device's direction, the network performance history, proximity to other network entities, the device location, the networks malfunctions, physical condition of user of the device, and any combination thereof.

It is another object of the present invention to disclose the system mentioned above, wherein technology for the communication module [130] is selected from a group comprised of: Bluetooth, Bluetooth Low Energy (BLE), Wi-Fi, Sub-Giga, cellular, ZigBee, Radio-frequency identification (RFID), and any combination thereof.

It is another object of the present invention to disclose the system mentioned above, wherein the SSID [135] is a string of at least one character.

It is another object of the present invention to disclose a method for delivering ad-hoc data of at least one device D_{i (i=1 . . . N)} [120]; the method comprising steps of:
a. providing each device Dᵢ [120] with a communication-module [130] configured for wireless communication with a predetermined environment [140]; and a non-transitory computer readable medium (CRM) [110] configured for controlling the communication module [130];
b. providing the CRM [110] with a coding-module [150] configured for assigning an updated SSID [135] for the communication-module [130];
c. periodically evaluating the data of the device Dᵢ [120];
d. periodically updating the SSID [135] to the communication-module [130]; and
e. broadcasting the SSID [135] to an environment [140];
wherein the SSID [135] is associated with the data; thereby implementing the wireless communication by utilizing its the SSID [135].

It is another object of the present invention to disclose the method mentioned above, further comprising a step of providing the environment [140] with a decoding-module [155], configured for decoding the SSID [135] back to the data.

It is another object of the present invention to disclose the method mentioned above, further comprising a step of decoding the SSID [135].

It is another object of the present invention to disclose the method mentioned above, further comprising a step of providing the coding-module [150] with a coding algorithm.

It is another object of the present invention to disclose the method mentioned above, further comprising a step of providing the decoding-module [155] with decoding algorithm.

It is another object of the present invention to disclose the method mentioned above, further comprising step of providing the CRM [120] and/or the environment [140] with a coding database [160].

It is another object of the present invention to disclose the method mentioned above, wherein the communication-module [130] does not require a password for wireless communication.

It is another object of the present invention to disclose the method mentioned above, wherein a password for the communication-module [130] is retrieved from the coding-database [160].

It is another object of the present invention to disclose the method mentioned above, wherein the communication-module [130] functions temporarily as a relay or an access-point, facilitating wireless communication from at least one other device D_{j≠i} [120] to the environment [140].

It is another object of the present invention to disclose the method mentioned above, further comprising a step of selecting the environment [140] from a group comprised of: wireless router, access point, mobile-phone, at least one other device D_{j≠i}, and any combination thereof.

It is another object of the present invention to disclose the method mentioned above, further comprising a step of selecting a time period, for the updating and the broadcasting, from a group comprised of: milliseconds, seconds, minutes, hours, days, and any combination thereof.

It is another object of the present invention to disclose the method mentioned above, wherein the SSID [135] of at least one device Dᵢ [120] is configured for reflecting the data delivered from at least one other device D_{j≠i} [120].

It is another object of the present invention to disclose the method mentioned above, further comprising a step of attaching at least one device Dᵢ [120] to an object and/or mammalian subject.

It is another object of the present invention to disclose the method mentioned above, further comprising a step of providing at least device Dᵢ [120] with at least one sensor [200], in communication with the CRM [110], selected from a group comprised of: accelerometer [201], GPS [202], gyro [203], magnetometer [204], sound detector [205], light detector [206], motion detector [207], thermometer [208], blood pressure monitoring device [209], blood glucose monitoring device [210], heart rate monitoring device [211], location-detector [212], proximity-detector [213], and any combination thereof.

It is another object of the present invention to disclose the method mentioned above, further comprising step of selecting the data from a group comprised of: reception quality, the network status, the network performance, battery status, connectivity level, accuracy, the sensor [200] availability, the sensor [200] readings, the device's direction, the network performance history, proximity to other network entities, the device location, the networks malfunctions, physical condition of user of the device, and any combination thereof.

It is still an object of the present invention to disclose the method mentioned above, further comprising a step of selecting technology for the communication module [130] from a group comprised of: Bluetooth, Bluetooth Low Energy (BLE), Wi-Fi, Sub-Giga, cellular, ZigBee, Radio-frequency identification (RFID), and any combination thereof.

It is lastly an object of the present invention to disclose the method mentioned above, wherein the SSID [135] is a string of at least one character.

### BRIEF DESCRIPTION OF THE DRAWINGS

The invention is herein described, by way of example only, with reference to the accompanying drawings, wherein:

FIG. 1, is a schematic diagram showing the present invention network system and its device's components;

FIG. 2, is a schematic diagram showing the present invention network system and its' communicating devices;

FIG. 3, is a schematic diagram demonstrating an example for an SSID string; and

FIG. 4, is a schematic diagram demonstrating the present invention's method and algorithm for communicating with its' devices.

### DETAILED DESCRIPTION OF PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a system and method for frequent change of SSID message for ad-hoc data delivery.

The term “SSID”, used herein stands for “Service Set Identifier.” An SSID is a unique ID that consists of up to 32 characters and is used for naming wireless networks. When multiple wireless networks overlap in a certain location, SSIDs make sure that data gets sent to the correct destination. Each packet sent over a wireless network includes the SSID, which ensures that the data being sent over the air arrives at the correct location. Without service set identifiers, sending and receiving data in a location with multiple wireless networks would be chaotic and unpredictable to say the least.

Because a wireless client device must provide the SSID in order to connect to the wireless application protocol (WAP), the SSID functions as a sort of password for the wireless network. However, because the WAP typically broadcasts the SSID in plain text, it does not provide any security. It is more realistic to think of the SSID as a network name that is applied to the grouping of the WAP and the devices currently connected to it. The administrator can accept a device's default SSID or specify an SSID manually to more clearly identify the device.

The term “Bluetooth”, used herein refers to a wireless radio protocol that is used to communicate from one device to another in a small area, usually less than 30 feet. Bluetooth is commonly used to enable communication between small personal electronic devices, such as between a cellular phone and a wireless earpiece or between an electronic organizer and a personal computer.

The present invention provides a wireless communication system [100] for delivering ad-hoc data (or message) from of at least one device D_{i (i=1 . . . N)} [120]; each device Dᵢ [120] comprising a communication-module [130] configured for the wireless communication with a predetermined environment [140], and a non-transitory computer readable medium (CRM) [110] configured to control the communication-module [130];

wherein the CRM [110] further comprising a coding-module [150] configured to periodically assign an updated SSID [135] to be broadcasted by the communication-module [130]; wherein the SSID [135] is associated with the data; such that the wireless communication is implemented by utilizing the SSID [135].

The present invention further provides a method for delivering ad-hoc data (or message) from at least one device D_{i (i=1 . . . N)} [120]; the method comprising steps of:
a. providing each device Dᵢ [120] with a communication-module [130] configured for wireless communication with a predetermined environment [140]; and a non-transitory computer readable medium (CRM) [110] configured for controlling the communication module [130];
b. providing the CRM [110] with a coding-module [150] configured for assigning an updated SSID [135] for the communication-module [130];
c. periodically evaluating the data of the device Dᵢ [120];
d. periodically updating the SSID [135] to the communication-module [130]; and
e. broadcasting the SSID [135] to an environment [140];
wherein the SSID [135] is associated with the data; thereby implementing the wireless communication by utilizing its the SSID [135].

According to an embodiment of the present invention, the environment [140] comprising a decoding-module [155] configured for decoding the SSID [135], back to the data.

According to another embodiment of the present invention, the SSID [135] is coded and/or decoded according to a predetermined coding-algorithm.

According to another embodiment of the present invention, the SSID [135] is coded and/or decoded according to a predetermined coding database [160], stored in the CRM [120] and/or the environment [140].

According to another embodiment of the present invention the communication-module [130] does not require a password for wireless communication.

According to another embodiment of the present invention, a password for the communication-module [130] is retrieved from the database [160].

According to another embodiment of the present invention, wherein the communication module [130], of at least one device, Dᵢ [120], is configured as a relay or an access point, facilitating wireless communication from at least one other device D_{j≠i} [120] to the environment [140].

According to another embodiment of the present invention the environment [140] is selected from a group comprised of: wireless router, access point, mobile-phone, at least one other device D_{j≠i}, and any combination thereof.

According to another embodiment of the present invention, the data of the device [120] is continuously and periodically updated and accordingly the SSID [135] is broadcasted in a time period selected from a group comprised of: milliseconds, seconds, minutes, hours, days, and any combination thereof.

According to another embodiment of the present invention, the SSID [135] of at least one device Dᵢ [120] is configured to reflect the data of at least one other device D_{j≠i} [120].

According to another embodiment of the present invention, at least one device Dᵢ [120] is physically attachable to an object, a human being, and/or an animal subject belonging to a group comprising mammals.

According to another embodiment of the present invention, at least one device Dᵢ [120] further comprising at least one sensor [200], in communication with the CRM [110], selected from a group comprised of: accelerometer [201], GPS [202], gyro [203], magnetometer [204], sound detector [205], light detector [206], motion detector [207], thermometer [208], blood pressure monitoring device [209], blood glucose monitoring device [210], heart rate monitoring device [211], location-detector [212], proximity-detector [213] and any combination thereof.

According to another embodiment of the present invention, the data is selected from a group comprised of: reception quality, the network status, the network performance, battery status, connectivity level, accuracy, the sensor [200] availability, the sensor [200] readings, the device's direction, the network performance history, proximity to other network entities, the device location, the networks malfunctions, physical condition of user of the device [120], and any combination thereof.

According to another embodiment of the present invention, a technology for the communication module [130] is selected from a group comprised of: Bluetooth, Bluetooth Low Energy (BLE), Wi-Fi, Sub-Giga, cellular, ZigBee, Radio-frequency identification (RFID), and any combination thereof.

According to another embodiment of the present, invention the SSID [135] is a string of at least one character.

According to another embodiment of the present invention, other side (the environment) decodes the SSID string and understands the derived data or message and is meaning.

According to another embodiment of the present invention, the system and method are configured for Many-To-Many communication via broadcast SSID string instead of normal peer-to-peer, increasing the communication range, saving battery and “awake time” of the device, without affecting the usability of the device receiving it. For example, a mobile phone can stay connected to any Wi-Fi Access-Point.

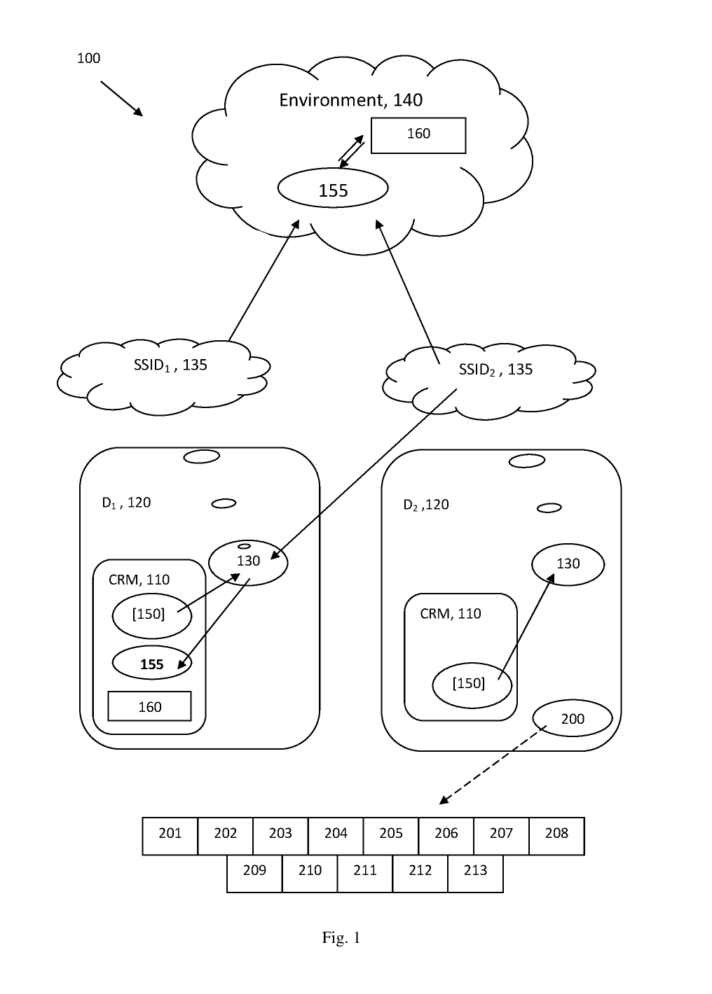

Reference is now made to FIG. 1 disclosing the above mentioned wireless communication system [100] for delivering ad-hoc data (or message) from at least one device D_{i (i=1 . . . N)} [120]. The device Dᵢ [120] includes a communication-module [130], configured for the wireless communication with a predetermined environment [140] (which can be another similar device D_{j≠i}), and a non-transitory computer readable medium (CRM) [110], configured to control the communication-module [130].

The CRM [110] further includes a coding-module [150], configured to periodically assign an updated SSID [135] to be broadcasted by the communication-module [130]. The updated SSID [135] of each communication-module [130] is associated with the content of its device's data. The data can be related to any of the sensors readings, an alert message, a call for help a status report, and more. The wireless communication disclosed herein is implemented by utilizing the SSID [135] of the communication-module [130].

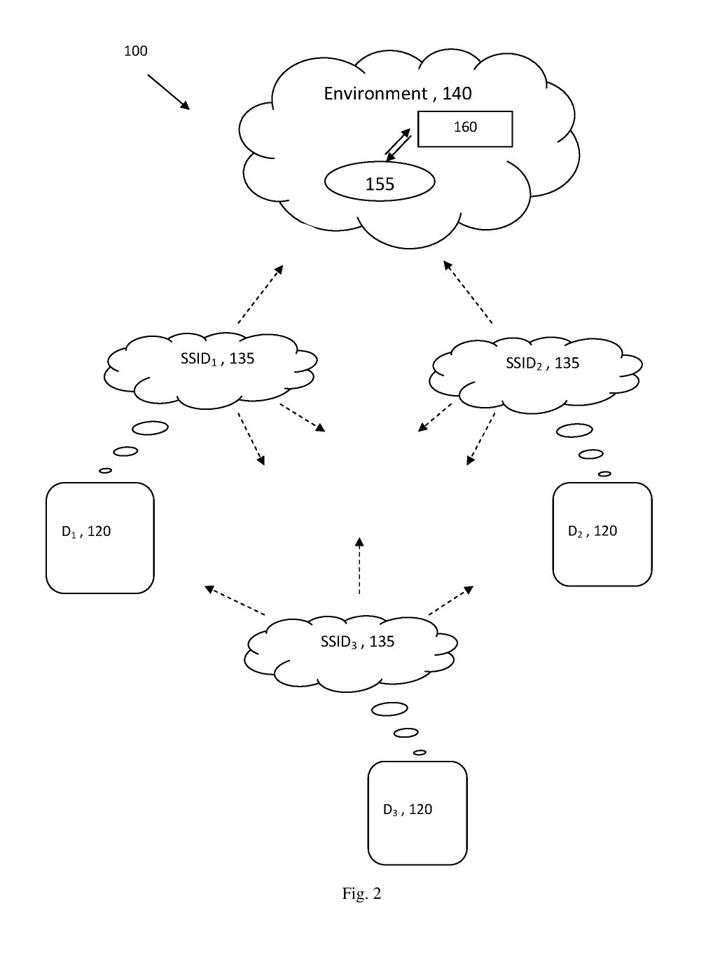

Reference is now made to FIG. 2, demonstrating a schematic diagram showing a network system with three communicating devices D₁, D₂ and D₃ [120] (in this example) communicating with one another and communicating with an environment [140]. Each of the devices [120] is broadcasting an SSID for its communication-module [130], and the CRM [110] of each device Dᵢ [120] can include the decoding-module and the database, so that it can decode and process messages or data being delivered from any other similar device D_{j≠i} [120].

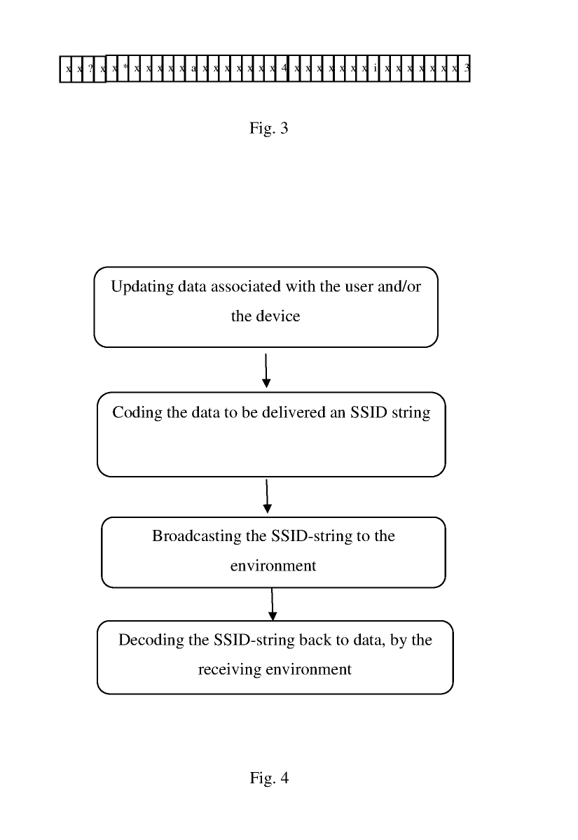

Reference is now made to FIG. 3, showing a schematic diagram for an SSID string example.

Reference is now made to FIG. 4, is a schematic diagram demonstrating the present invention's basic method and algorithm for communicating with its devices [120]. The method includes: evaluating and updating data associated with user and/or the device; coding the data to be delivered to an SSID string of characters; broadcasting the SSID [135] to the environment [140]; and decoding the SSID-string back to the original data, by the receiving environment [140], which can also be another similar device D_{j≠i} [120].

### BACKGROUND OF THE INVENTION

An SSID is a unique ID that consists of up to 32 characters and is used for naming wireless networks. When multiple wireless networks overlap in a certain location, SSIDs make sure that data gets sent to the correct destination. Each packet sent over a wireless network includes the SSID, which ensures that the data being sent over the air arrives at the correct location. Without service set identifiers, sending and receiving data in a location with multiple wireless networks would be chaotic and unpredictable to say the least.

There is an unmet need for a system or method that frequently changes the SSID of a communicating device to a message for delivering ad-hoc data or information for applications like Many-To-Many devices communication.

1-32. (canceled)

33. A wireless communication system [100] for delivering ad-hoc data from at least one device, D_{i (i=1 . . . N)}, [120], with each said device Dᵢ [120] comprising a communication-module [130] configured for said wireless communication with a predetermined environment [140], and a non-transitory computer readable medium (CRM) [110] configured to control said communication-module [130]; and
wherein said CRM [110] further comprises a coding-module [150] configured to assign an updated SSID [135] to be broadcasted by said communication-module [130]; and wherein said SSID [135] is associated with said data;
such that said wireless communication is implemented by utilizing said SSID [135];
further wherein said data of said device [120] is continuously and periodically updated, and accordingly an updated SSID [135] is broadcasted in a time period selected from a group comprised of: milliseconds, seconds, minutes, hours, days, and any combination thereof.

34. The system [100] according to claim 33, wherein said environment [140] comprises a decoding-module [155], configured for decoding said SSID [135] back to said data.

35. The system [100] according to claim 33, wherein said SSID [135] is coded and/or decoded according to a predetermined coding-algorithm.

36. The system [100] according to claim 33, wherein said SSID [135] is coded and/or decoded according to a predetermined a coding-database [160], stored in said CRM [120] and/or said environment [140].

37. The system [100] according to claim 36, wherein a password for said communication-module [130] is retrieved from said database [160].

38. The system [100] according to claim 33, wherein said communication module [130], of at least one said device, Dᵢ [120], is configured as a relay or an access-point facilitating wireless communication from at least one other said device, D_{j≠i} [120], to said environment [140].

39. The system [100] according to claim 33, wherein said environment [140] is selected from a group comprised of: wireless router, access point, mobile phone, at least one other said device D_{j≠i}, and any combination thereof.

40. The system [100] according to claim 33, wherein at least one said device Dᵢ [120] further comprises at least one sensor [200], in communication with said CRM [110], selected from a group comprised of: accelerometer [201], GPS [202], gyro [203], magnetometer [204], sound detector [205], light detector [206], motion detector [207], thermometer [208], blood pressure monitoring device [209], blood glucose monitoring device [210], heart rate monitoring device [211], location-detector [212], proximity-detector [213], and any combination thereof.

41. The system [100] according to claim 33, wherein said data is selected from a group comprised of: reception quality, said network status, said network performance, battery status, connectivity level, accuracy, said sensor's [200] availability, said sensor's [200] readings, said device's direction, said network performance history, proximity to other network entities, said device location, said network's malfunctions, physical condition of user of said device, and any combination thereof.

42. The system [100] according to claim 33, wherein technology for said communication module [130] is selected from a group comprised of: Bluetooth, Bluetooth Low Energy (BLE), Wi-Fi, Sub-Giga, cellular, ZigBee, Radio-frequency identification (RFID), and any combination thereof.

43. A method for delivering ad-hoc data from at least one device D_{i (i=1 . . . N)} [120]; said method comprising steps of:
a. providing each said device D₁ [120] with a communication-module [130] configured for wireless communication with a predetermined environment [140]; and a non-transitory computer readable medium (CRM) [110] configured for controlling said communication module [130];
b. providing said CRM [110] with a coding-module [150] configured for assigning an updated SSID [135] for said communication-module [130];
c. evaluating said data of said device Dᵢ [120];
d. updating said SSID [135] to said communication-module [130]; and
e. broadcasting said SSID [135] to an environment [140];
wherein said SSID [135] is associated with said data; thereby implementing said wireless communication by utilizing its said SSID [135]; and
further wherein said method further comprises a step of:
f. periodically performing said evaluating, said updating and said broadcasting, at a period selected from a group comprised of: milliseconds, seconds, minutes, hours, days, and any combination thereof.

44. The method according to claim 43, further comprising a step of providing said environment [140] with a decoding-module [155], configured for decoding said SSID [135] back to said data.

45. The method according to claim 43, further comprising a step of coding or decoding said SSID [135] according to a coding or decoding algorithm.

46. The method according to claim 43, further comprising step of providing said CRM [120] and/or said environment [140] with a coding database [160].

47. The method according to claim 46, wherein a password for said communication-module [130] is retrieved from said coding database [160].

48. The method according to claim 43, wherein said communication-module [130] functions temporarily as a relay or an access-point, facilitating wireless communication from at least one other said device D_{j≠i} [120] to said environment [140].

49. The method according to claim 43, further comprising a step of selecting said environment [140] from a group comprised of: wireless router, access point, mobile-phone, at least one other said device D_{j≠i}, and any combination thereof.

50. The method according to claim 43, further comprising a step of providing at least one said device Dᵢ [120] with at least one sensor [200], in communication with said CRM [110], selected from a group comprised of: accelerometer [201], GPS [202], gyro [203], magnetometer [204], sound detector [205], light detector [206], motion detector [207], thermometer [208], blood pressure monitoring device [209], blood glucose monitoring device [210], heart rate monitoring device [211], location-detector [212], proximity-detector [213], and any combination thereof.

51. The method according to claim 43, further comprising a step of selecting said data from a group comprised of: reception quality, said network status, said network performance, battery status, connectivity level, accuracy, said sensor [200] availability, said sensor [200] readings, said device's direction, said network performance history, proximity to other network entities, said device location, said network's malfunctions, physical condition of user of said device, and any combination thereof.

52. The method according to claim 43, further comprising a step of selecting technology for said communication module [130] from a group comprised of: Bluetooth, Bluetooth Low Energy (BLE), Wi-Fi, Sub-Giga, cellular, ZigBee, Radio-frequency identification (RFID), and any combination thereof.
